(19) United States
(12) Patent Application Publication
(10) Pub. No.: US 2023/0177720 A1
(43) Pub. Date: Jun. 8, 2023

(54) METHOD, SYSTEM AND COMPUTER PROGRAM PRODUCT FOR DETERMINING THE POSE OF A MOBILE UNIT

(71) Applicant: CARIAD SE, Wolfsburg (DE)

(72) Inventors: Jonas HOFFMANN, Berlin (DE); Michael HOLICKI, Berlin (DE)

(21) Appl. No.: 17/922,325

(22) PCT Filed: Apr. 28, 2021
(86) PCT No.: PCT/EP2021/061112

§ 371 Date: Oct. 28, 2022

(30) Foreign Application Priority Data
Apr. 29, 2020 (DE) 10 2020 111 659.4

(51) Int. Cl. G06T 7/73; G06T 7/30

(52) U.S. Cl. CPC G06T 7/74; G06T 7/30

(57) ABSTRACT

A method for determining the pose of a mobile unit having at least one sensor device, which is designed to register environment images of the mobile unit, and a map, in which at least one passable region is marked, includes registering at least one environment image by of the at least one sensor device and using the at least one registered environment image to calculate at least one collision-free region, and determining the pose of the mobile unit by a comparison of the at least one calculated collision-free region with the at least one passable region marked on the map. Furthermore, a system for carrying out the method is also described.

### BACKGROUND

### Technical Field

Embodiments of the invention relate to a method, system and computer program product for determining the pose of a mobile unit.

### Description of the Related Art

Localization methods, which can be used for example in robotics or in the field of autonomous driving, serve for a precise determination of a pose or position of a vehicle. Landmarks are used for this, such as traffic signs or traffic lights, which are detected in an image registered by a camera, classified, and then matched up with a known landmark having predetermined position indications. The pose of position of the vehicle can then be determined from such a matching, for example.

The accuracy of such a method depends greatly on the number of landmarks detected and the clarity of the matching of the detected landmarks with the known landmarks. In particular, in regions where only a few or no landmarks can be detected, or a clear matching cannot be achieved, such a method cannot be carried out, or the accuracy of the method is inadequate.

Some embodiments avoid the stated drawbacks and to propose a reliable and precise method, system and computer program product for determining the pose of a mobile unit.

### BRIEF SUMMARY

Some embodiments relate to a method for determining the pose of a mobile unit having at least one sensor device, which is designed to register environment images of the mobile unit, and a map, on which at least one passable region is marked. In the method, at least one environment image is registered by means of the at least one sensor device and the at least one registered environment image is used to calculate at least one collision-free region. The pose of the mobile unit is determined by a comparison of the at least one calculated collision-free region with the at least one passable region marked on the map.

With the proposed method, the pose of a mobile unit can be determined in especially reliable and flexible manner. The method can be used in environments of the mobile unit where few or no landmarks can be detected or for which few or no landmarks are known or marked on a map, such as small side roads or remote and little traveled regions. In particular, the method can be used when the matching up of detected and known landmarks in a landmark-based localization method cannot be determined unambiguously or reliably. In such demanding situations, a collision-free region can always still be computed reliably and robustly with the aid of the at least one registered environment image and the comparison can be carried out with the at least one passable region marked on the map.

The mobile unit can be, for example, a land vehicle, such as a motor vehicle or a robot, or a water vehicle, such as a boat or a ship. The pose of the mobile unit can encompass at least position indications. Position indications can be formed for example with values for two or three coordinates. The pose can also encompass angle of orientation indications. Angle of orientation indications can be formed for example with values for two or three angles of orientation. The pose of the mobile unit may encompass both position indications and angle of orientation indications. For example, a pose can be represented by a vector having six components. Three of the components can correspond to coordinates, such as geographical coordinates or GPS coordinates (GPS=Global Positioning System). Three other components can correspond to angles of orientation.

The at least one marked passable region can correspond at least partly to a partial region of a road surface or a water surface. The map may comprise map position indications for the at least one marked passable region. A map position indication can be formed with values for two or three coordinates in a map coordinates system. For example, the at least one marked passable region can be determined by a two-dimensional or three-dimensional point or pixel set. The at least one marked passable region may correspond to a two-dimensional surface or point set in a two-dimensional or three-dimensional map coordinates system. The map coordinates system can be a global reference system, which can be formed for example with geographical coordinates or GPS coordinates.

The map can be a semantic map. The map may comprise at least one known landmark with map position indications. The at least one landmark can be for example a traffic sign, a traffic light, or a hydrant. The map position indication of a landmark can comprise values for two or three coordinates of the respective landmark in the map coordinates system.

The at least one sensor device can comprise a camera, such as a monocamera. The at least one sensor device may be used to perform a calibration. By means of the calibration, a point or pixel of the at least one environment image can be matched up with at least one coordinate, such as a height relative to the local ground level of the mobile unit. The local ground level of the mobile unit can correspond to at least one partial region of the passable surface of the mobile unit. For example, the local ground level can be determined by the points of bearing of the wheels of the mobile unit on the passable surface of the mobile unit.

The calibration can be carried out with the aid of a camera coordinates system, the optical axis of the camera as at least one sensor device corresponding to a coordinates axis of the camera coordinates system. Furthermore, the height of the at least one sensor device, the mobile unit, or the optical axis relative to the local ground level of the mobile unit can be predetermined and or taken into account during the calibration.

The at least one collision-free region can be a two-dimensional point or three-dimensional point or pixel set. For example, the at least one collision-free region can correspond to a two-dimensional or three-dimensional point set in the camera coordinates. The at least one collision-free region can be calculated as a partial region of the surface registered with the at least one environment image and passable for the mobile unit, such as the road surface or the water surface. In particular, the at least one collision-free region can form the region of the passable surface of the mobile unit which can be reached by the mobile unit proceeding in the direction of travel. The at least one collision-free region can be in particular free of obstacles, such as other mobile units, sidewalks, or hydrants.

The at least one collision-free region can be extracted as a mask from the at least one environment image, where each pixel of the at least one environment image can be associated with a bit value. For example, a pixel with the bit value 1 can be associated with the collision-free region, while a pixel with the bit value 0 can be associated with the complement of the collision-free region. The mask so defined can be represented by a binary matrix, where the row and column arrangement of the pixels can correspond to the rows and columns of the binary matrix.

The at least one collision-free region may be calculated with the aid of the at least one environment image by means of semantic segmentation. The at least one collision-free region may be calculated by means of a machine learning method, especially by means of a trained neural net.

The method can involve an initialization step. For example, a position or pose of the mobile unit can be estimated initially by means of at least one further sensor device. The at least one further sensor device can comprise, for example, a satellite location system for the detecting of GPS data, at least one speed sensor for detecting of odometry data, and or a LIDAR system (LIDAR=light detection and ranging). For example, the map can be retrieved or obtained with the aid of the initially estimated pose or position of the mobile unit via a mobile communication network, via an external server, and or from an electronic storage unit of the mobile unit.

The method can also involve a geometrical projection. For example, the calculated at least one collision-free region can be projected onto the local ground level of the mobile unit, such as with the aid of the calibration. The at least one passable region marked on the map, for example with the aid of the initially estimated pose or position of the mobile unit or with the aid of a hypothesis for the pose of the mobile unit, may also be projected onto the local ground level of the mobile unit. Thanks to such a geometrical projection, the comparison of the at least one calculated collision-free region with the at least one passable region marked on the map can be done especially quickly and efficiently.

The proposed method can be combined with a localization method known in itself, especially a landmark-based localization method. For example, at first at least one hypothesis can be determined or calculated for the pose of the mobile unit by means of a known localization method, especially by means of a landmark-based localization method.

A plausibility check can be carried out during the comparison of the at least one calculated collision-free region with the at least one passable region as marked on the map. By means of the plausibility check, one can verify or determine the plausibility of the at least one hypothesis or select one hypothesis, such as one plausible hypothesis, from multiple hypotheses and take it into account when determining the pose of the mobile unit. Alternatively or additionally, the plausibility of the initially estimated pose of the mobile unit can also be determined by means of the plausibility check.

The localization method may be a landmark-based localization method. The landmark-based localization method can involve a detection and or a classification of at least one landmark in the at least one environment image. For example, a detection can be done with the aid of a trained neural net. Alternatively or additionally, a classification can be performed with the aid of a trained neural net.

The at least one hypothesis for the pose of the mobile unit can be determined by matching up at least one landmark detected in the at least one registered environment image with at least one known landmark marked on the map. For this, the localization method can comprise for example a particle filter or a Kalman filter, such as a multi-hypothesis Kalman filter.

It may happen that a matching up of multiple detected landmarks with multiple known landmarks cannot be done unambiguously by means of a landmark-based localization method. In this case, multiple hypotheses can be determined. Each hypothesis can correspond to a specific matching of the multiple detected landmarks with the multiple known landmarks. A hypothesis for the pose of the mobile unit can then be determined for a respective matching or hypothesis by means of the landmark-based localization method.

If multiple hypotheses are determined by means of the localization method, the plausibility check can be performed for all of these hypotheses. Then, if multiple plausible hypotheses are determined, a weighting of the multiple plausible hypotheses can also be carried out during the comparison or during the plausibility check.

The plausibility check can involve a determination of the partial region or the partial set of the at least one collision-free region that can be unambiguously matched up with the at least one passable region marked on the map with the aid of the at least one hypothesis. For the comparison or the plausibility check, the at least one collision-free region and the at least one passable region can be transformed with the aid of the at least one hypothesis and a corresponding coordinates transformation into a common coordinates system.

The at least one collision-free region and the at least one passable region may be projected with the aid of the at least one hypothesis and or with the aid of the calibration onto a surface in a common coordinates system. The surface can correspond for example to the local ground level of the mobile unit. The surface can also correspond to the surface defined on the map by the marked passable region. The surface can also correspond to a surface or hypersurface in the map coordinates system or in the camera coordinates system as defined by the at least one marked passable region.

A hypothesis can be plausible if the ratio between the size of a partial region of the collision-free region which can be matched up with the marked passable region with the aid of the at least one hypothesis and its complement exceeds a critical value. A weighting of the plausible hypotheses can also be determined with the aid of the ratio so determined for the size of the determined partial region and its complement.

For example, an intersection can be determined for the at least one collision-free region and the at least one marked passable region projected onto a common surface. The number of valid pixels can correspond to the number of pixels contained in the intersection (pixels which can be unambiguously associated with the at least one marked passable region). The number of invalid pixels can correspond to the number of pixels which are contained in the at least one collision-free region, but do not belong to the intersection (pixels which cannot be unambiguously associated with the at least one marked passable region).

During the plausibility check, the ratio of the number of valid pixels to the number of invalid pixels can then be compared to a predetermined critical value. If the predetermined critical value is exceeded, the at least one hypothesis can be classified as plausible. A weighting of multiple plausible hypotheses can then be determined with the aid of the ratio of the number of valid pixels to the number of invalid pixels, the largest weight corresponding to the largest ratio, in absolute magnitude, between the number of valid pixels and the number of invalid pixels.

During the comparison, the plausibility check can be used to determine the pose of the mobile unit or a new estimate of the pose of the mobile unit. For example, the pose of the mobile unit as determined by means of the comparison can correspond to a plausible hypothesis. The pose of the mobile unit as determined by the comparison can also the initially estimated pose of the mobile unit. If, for example, no plausible hypothesis can be determined by means of the plausibility check, the pose of the mobile unit as determined by means of the comparison can correspond to the initially estimated pose of the mobile unit. If multiple plausible hypotheses are determined by means of the plausibility check and the comparison involves a weighting of the multiple plausible hypotheses, then the pose of the mobile unit as determined by the comparison can also correspond to the plausible hypothesis with the largest weighting.

Alternatively or additionally to the localization method, multiple hypotheses for the pose of the mobile unit can also be determined as initial values or initial vectors in the form of a regular or random grid. The grid can be determined for example with the aid of the initially estimated position or pose of the mobile unit or it may contain these as an initial value or as an initial vector. The position indications and or the angle of orientation indications of the so determined hypotheses as point clouds in a coordinates system can correspond for example to a two-dimensional or three-dimensional Bravais grid, such as a quadratic or cubic grid. Alternatively, the multiple hypotheses as initial vectors can also be generated randomly, by means of a random number generator.

Alternatively or additionally to the plausibility check, an updating of the pose or position of the mobile unit can occur.

For the updating of the poses or position of the mobile unit, a minimization of a cost function can be done during the comparison of the at least one calculated collision-free region with the at least one passable region marked on the map. The cost function can indicate, for at least one hypothesis, a characteristic distance between the at least one calculated collision-free region and the at least one passable region marked on the map in a common coordinates system. The minimum of the cost function can be determined by means of an optimization method, such as by means of the method of least squares, by means of Monte Carlo simulation, by means of linearization in the correction step of a Kalman filter, or by means of the method of simulated annealing. The pose of the mobile unit as determined by the comparison can correspond to the minimum of the cost function. The at least one characteristic distance can be determined with the aid of the shortest distance between a respective three-dimensional point which can be associated with the at least one collision-free region and the surface defined on the map by the at least one marked passable region. For example, the at least one characteristic distance can correspond to an averaged value or to the sum of all shortest distances so determined.

The minimization of the cost function may be used to determine an updating of a position or pose of the mobile unit.

In one embodiment, the minimization of the cost function is performed for one or more hypotheses determined by means of a localization method. Thus, the minimization of the cost function or the optimization method can also be combined with a landmark-based localization method.

It would also be possible to perform the minimization of the cost function for multiple ad-hoc hypotheses determined as initial values or initial vectors. A minimization of the cost function or the optimization method can then be used in environments of the mobile unit where no landmark can be detected or for which no known landmarks are marked on the map and therefore a landmark-based localization method cannot be carried out. It may also be provided that an initially estimated pose of the mobile unit is determined by means of the further sensor device, at least one hypothesis is determined by means of a localization method, and or at least one further hypothesis is determined by means of the minimization of a cost function. For the initially estimated pose, the at least one hypothesis and or the at least one further hypothesis, a plausibility check can also be performed. With the aid of the comparison of the at least one calculated collision-free region with the at least one passable region marked on the map, the pose of the mobile unit can be determined such that it corresponds to the initially estimated pose, the at least one hypothesis, or the at least one further hypothesis.

Some embodiments also relate to a system, comprising a mobile unit having at least one sensor device, an electronic storage unit, and an electronic evaluation and control unit. The at least one sensor device is designed to register at least one environment image of the mobile unit. A map, having at least one passable region marked on the map, is stored in the electronic storage unit. The electronic evaluation and control unit is adapted to compute at least one collision-free region with the aid of at least one environment image registered by means of the at least one sensor device. The electronic evaluation and control unit is also adapted to determine a pose of the mobile unit by comparison of the at least one collision-free region with the at least one passable region marked on the map.

The at least one sensor device may comprise a calibrated monocamera. The electronic evaluation and control unit may be adapted to compute the at least one collision-free region with the aid of an environment image sequence registered by means of the calibrated monocamera.

It would also be possible for the at least one sensor device to comprise a 3D sensor, such as a LiDAR sensor.

The at least one sensor device can also comprise a combination of one or more 3D sensors and/or one or more 2D sensors, such as multiple cameras.

The electronic storage unit can be part of the electronic evaluation and control unit or be electronically connected to an external server. The electronic storage unit can be a ROM or a RAM storage.

The electronic evaluation and control unit can involve a CPU (central processing unit), a GPU (graphical processing unit) and or a computer unit. The system, the mobile unit, and or the electronic evaluation and control unit can also comprise at least one further sensor device and or a mobile communication system.

The at least one further sensor device can be adapted to initially estimate a pose or position of the mobile unit. For example, the at least one further sensor device can involve a satellite location system, such as a GPS (Global Positioning System), or be configured as part of a satellite location system. The at least one further sensor device can also comprise at least one speed sensor for estimation of odometry data.

The mobile communication system can be a WLAN-capable (WLAN=wireless local area network) and or a mobile radio-capable communication system. For example, the mobile communication system can be adapted to retrieve or obtain the map via an external server from an electronic storage unit.

Some embodiments also provide a computer program product. The computer program product comprises a computer program (or a sequence of commands). The computer program comprises software means to carry out a method as described above or to actuate a system as described above when the computer program is running in a computer unit.

The computer program product can be loaded directly into an internal electronic memory or a storage unit of the computer unit or it is already stored therein and it typically contains portions of a program code for carrying out the described method when the computer program product is running or executed on the computer unit. The program code or portions of the program code can be written in a script language or a compiler language, such as C, C++ or Python. The computer program product can be stored on a machine-readable medium, such as a digital storage medium.

### BRIEF DESCRIPTION OF THE SEVERAL VIEWS OF THE DRAWINGS

Embodiments are represented in the drawings and will be explained below with the aid of FIGS. 1 to 2.

FIG. 1 shows a schematic representation of a registered environment image with a calculated collision-free region.

FIG. 2 shows a schematic representation of a map with a marked passable region.

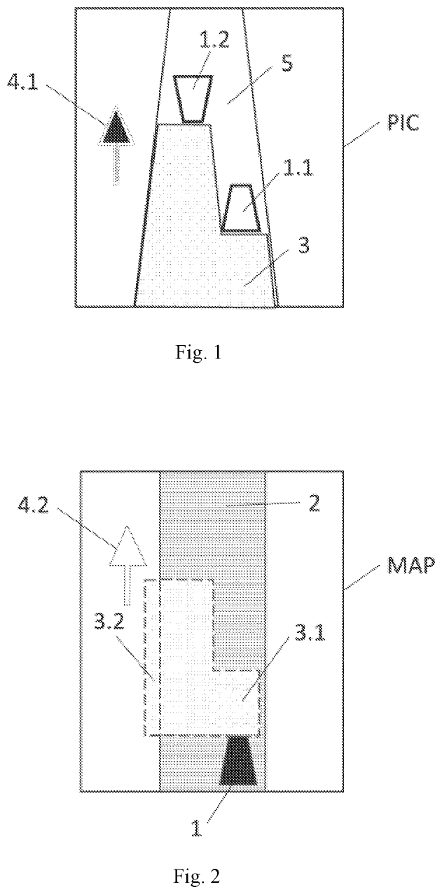

In the following, recurring features in FIGS. 1 and 2 are provided each time with identical reference numbers.

### DETAILED DESCRIPTION

FIG. 1 shows a schematic representation of an environment image PIC of a vehicle as the mobile unit 1 (not shown), which has been registered by means of a monocamera. With the aid of the environment image PIC, a collision-free region 3 is calculated by means of a machine learning method and marked in the environment image PIC. The collision-free region 3 corresponds to the partial region of the road surface 5 which is passable in the direction of travel. In FIG. 1, the collision-free region 3 is bordered by a vehicle 1.1 traveling ahead of the mobile unit 1 and by a vehicle 1.2 coming toward the mobile unit 1. Furthermore, a traffic sign is detected as a landmark 4.1 by means of a trained neural net with the aid of the environment image PIC.

FIG. 2 shows a schematic representation of a semantic map MAP with a marked passable region 2 and a known landmark 4.2. The map MAP also contains map position indications for the known landmark 4.2.

The pose of the mobile unit 1 is determined by a comparison of the at least one collision-free region 3 with the at least one passable region 2 marked on the map. For this, at first a GPS-systems is used to initially estimate a position of the mobile unit 1. The initially estimated position of the mobile unit 1 is used to match up the landmark 4.1 detected in the environment image PIC with the known landmark 4.2 marked on the map MAP by means of a known landmark-based localization method. The match-up and the map position indications of the known landmark 4.2 are used to determine a hypothesis for the pose of the mobile unit 1 by means of the known landmark-based localization method.

With the aid of the hypothesis for the pose of the mobile unit 1 and a predetermined calibration of the monocamera, the collision-free region 3 which has been calculated and marked in the environment image PIC in FIG. 1 is projected onto the passable region 2 marked on the map MAP. In FIG. 2, the projection of the collision-free region 3 which is calculated and marked in the environment image PIC corresponds to the partial regions 3.1, 3.2 on the passable region 2 marked on the map MAP.

During the comparison, a plausibility check of the hypothesis for the pose of the mobile unit 1 is then carried out. During the plausibility check, the partial region 3.1 of the calculated collision-free region 3, 3.1, 3.2 is determined which can be unambiguously matched up with the passable region 2 marked on the map MAP. The number of valid pixels then corresponds to the number of the pixels contained in the partial region 3.1. The number of invalid pixels corresponds to the number of pixels contained in the partial region 3.2. The partial region 3.2 is the complement of the partial region 3.1. The higher the number of valid pixels, the more plausible the hypothesis for the pose of the mobile unit 1. In particular, the ratio between the number of valid pixels and the number of invalid pixels is compared to a given critical value. Plausibility obtains if the ratio so determined is larger than the given critical value. For the example shown in FIG. 2, the given critical value is 4. The ratio between the number of valid pixels and the number of invalid pixels is 5. Thus, the hypothesis determined by means of the landmark-based localization method is plausible. The pose of the mobile unit 1 as determined by the comparison of the calculated collision-free region 3 and the passable region 2 marked on the map MAP then corresponds to the plausible hypothesis for the pose of the mobile unit 1.

In another embodiment, multiple landmarks 4.1 are detected in the environment image PIC. The map MAP also contains multiple known landmarks 4.2, each with map position indications. The initially estimated position of the mobile unit 1 is used to determine multiple hypotheses by means of the known landmark-based localization method. Each hypothesis matches up the detected landmarks 4.1 with a known landmark 4.2. For each hypothesis of the matching, the map position indications of the respectively matched-up known landmarks 4.2 are then used to determine a hypothesis for the pose of the mobile unit 1.

For each of the hypotheses so determined, the calculated collision-free region 3 is projected onto the passable region 2 marked on the map MAP and each time the ratio between the number of valid pixels and the number of invalid pixels is determined. Furthermore, the ratio so determined is used to determine a weighting of the particular hypotheses, the hypothesis with the largest ratio so determined being given the greatest weight. The pose of the mobile unit 1 so determined by the comparison then corresponds to the hypothesis for the pose of the mobile unit 1 with the greatest weight.

In another embodiment, no landmark-based localization method is performed. Instead, 10000 hypotheses are randomly determined for the pose of the mobile unit 1 by means of a random number generator.

A minimization of a cost function is then performed during the comparison, wherein the cost function indicates, for each of the randomly determined hypotheses, a characteristic distance between the calculated collision-free region 3 and the passable region 2 marked on the map MAP in a common coordinates system. In order to determine the characteristic distance, a coordinates transformation of the calculated collision-free region 3 from the camera coordinates system to the map coordinates system is carried out with the aid of the respective hypothesis and the shortest distances are determined between a respective three-dimensional point of the at least one collision-free region 3 and the surface defined on the map MAP by the marked passable region 2. The sum of the shortest distances so determined then corresponds to the characteristic distance.

The cost function is minimized by means of the linearization in the correction step of a Kalman filter. The pose of the mobile unit 1 as determined with the aid of the comparison then corresponds to the minimum of the cost function and it is used to determine an updating of the pose of the mobile unit 1.

The methods described in the embodiments are carried out with a system comprising a mobile unit 1 having a monocamera as the sensor device, an electronic storage unit, and an electronic evaluation and control unit. The system also comprises a GPS system. The monocamera is adapted to register environment images of the mobile unit 1. The map MAP with the marked passable region 2 is saved in the electronic storage unit. The electronic evaluation and control unit is adapted to calculate the collision-free region 3 with the aid of an environment image sequence registered by means of the monocamera. The electronic evaluation and control unit is also adapted to determine the pose of the mobile unit 1 by comparison of the collision-free region 3 with the passable region 2 marked on the map MAP.

Features of the different embodiments can be combined with each other and provided individually.

In general, in the following claims, the terms used should not be construed to limit the claims to the specific embodiments disclosed in the specification and the claims, but should be construed to include all possible embodiments along with the full scope of equivalents to which such claims are entitled.

1. A method for determining a pose of a mobile unit having at least one sensor device, which is designed to register environment images of the mobile unit and a map, in which at least one passable region is marked, comprising:
registering at least one environment image by the at least one sensor device, and using the at least one registered environment image to calculate at least one collision-free region, and
determining the pose of the mobile unit by a comparison of the at least one calculated collision-free region with the at least one passable region marked on the map.

2. The method according to claim 1, wherein the pose of the mobile unit encompasses position indications and/or angle of orientation indications and/or the at least one marked passable region corresponds to a two-dimensional point set or a three-dimensional point set in a map coordinates system.

3. The method according to claim 1, wherein the map is a semantic map and/or it comprises at least one known landmark with map position indications.

4. The method according to claim 1, wherein the at least one collision-free region corresponds to a two-dimensional point set or a three-dimensional point set in a camera coordinates system and/or the at least one collision-free region corresponds to a collision-free passable surface emerging from the mobile unit in the direction of travel and/or the at least one collision-free region is calculated with the aid of at least two sequentially registered environment images and/or the at least one collision-free region is calculated with the aid of a monocular environment image sequence and/or the at least one collision-free region is calculated by means of semantic segmentation and/or the at least one collision-free region is calculated by means of a machine learning method, especially by means of a trained neural net.

5. The method according to claim 1, wherein the calculated at least one collision-free region and/or the at least one passable region marked on the map is projected onto the local ground level of the mobile unit.

6. The method according to claim 1, wherein at least one hypothesis for the pose of the mobile unit is calculated by means of a localization method and a plausibility check is performed during the comparison of the at least one calculated hypothesis.

7. The method according to claim 6, wherein the localization method is a landmark-based localization method and/or the at least one hypothesis for the pose of the mobile unit is determined by matching up at least one landmark detected in the registered environment image with at least one known landmark marked on the map and/or multiple hypotheses are determined for the pose of the mobile unit by means of a landmark-based localization method.

8. The method according to claim 6, wherein during the plausibility check the partial region of the at least one collision-free region that is unambiguously matched up with the at least one passable region marked on the map is determined with the aid of the at least one hypothesis and/or the at least one hypothesis is plausible if the ratio between the size of a partial region of the at least one collision-free region which can be matched up with the at least one marked passable region with the aid of the at least one hypothesis and its complement exceeds a critical value.

9. The method according to claim 6, wherein the pose of the mobile unit determined by the comparison corresponds to a plausible hypothesis and/or a pose of the mobile unit is initially estimated by means of a further sensor device and the pose of the mobile unit as determined by the comparison corresponds to the initially estimated pose of the mobile unit or a plausible hypothesis and/or multiple plausible hypotheses are determined by means of the plausibility check and the comparison involves a weighting of the multiple plausible hypotheses and the pose of the mobile unit as determined by the comparison corresponds to the largest weight.

10. The method according to claim 1, wherein at least one hypothesis is determined for the pose of the mobile unit and during the comparison a minimization of a cost function is performed, where the cost function indicates the distance between the at least one calculated collision-free region and the passable region marked on the map in a common coordinates system, and the pose of the mobile unit corresponds to the minimum of the cost function.

11. The method according to claim 10, wherein the at least one characteristic distance is determined by means of the shortest distances between a respective three-dimensional point of the at least one collision-free region and the surface defined on the map by the marked at least one passable region.

12. The method according to claim 10, wherein an updating of the pose of the mobile unit is done by minimizing a cost function.

13. A system, comprising:
a mobile unit having at least one sensor device, which is designed to register environment images of the mobile unit,
an electronic storage unit, in which a map is stored having at least one passable region, and
an electronic evaluation and control unit which is adapted to calculate at least one collision-free region with the aid of at least one environment image registered by means of the at least one sensor device, and to determine a pose of the mobile unit by a comparison of the at least one collision-free region with the at least one passable region marked on the map.

14. The system according to claim 13, wherein the system and/or the mobile unit and/or the electronic evaluation and control unit comprises at least one further sensor device, while the at least one further sensor device involves a satellite location system and/or a mobile communication system.

15. The system of claim 13, further comprising a computer program product, comprising a computer program, containing software for carrying out a method for determining a pose of the mobile unit when the computer program is running in a computer unit, the method comprising:
registering at least one environment image, by the at least one sensor device, and using the at least one registered environment image to calculate at least one collision-free region, and
determining the pose of the mobile unit by a comparison of the at least one calculated collision-free region with the at least one passable region marked on the map.
